(19) United States
(12) Patent Application Publication
(10) Pub. No.: US 2016/0369538 A1
(43) Pub. Date: Dec. 22, 2016

(54) BOLT ACTION LOCKING APPARATUS FOR SLIDING DOOR

(71) Applicant: Henry Franklin Ledford, High Point, NC (US)

(72) Inventor: Henry Franklin Ledford, High Point, NC (US)

(21) Appl. No.: 14/746,705

(22) Filed: Jun. 22, 2015

(51) Int. Cl. E05C 3/02; E05B 15/02; E05C 1/02

(52) U.S. Cl. CPC E05C 3/02; E05C 1/02; E05B 15/0205

(57) ABSTRACT

A bolt action locking apparatus for use with a conventional sliding bolt lock assembly that enables a laterally sliding door to be locked and unlocked through the extension and retraction of the assembly's locking bolt comprises a modified face plate configured for attachment to the bolt casing of the assembly for use in place of the conventional face plate and a strike plate adapted to be positioned on a doorjamb in place of a conventional strike plate for a sliding bolt lock. The modified face plate includes a bolt aperture for allowing a locking bolt exiting from the bolt casing to pass through and a locking body configured to hinge between a first position and second position based on the position of the locking bolt. The strike plate includes an enlarged locking aperture adapted to receive the locking body while in the first position and secure it when moved to the second position.

### BRIEF DESCRIPTION OF THE DRAWINGS

FIG. 1 is a front perspective view of a modified face plate of a bolt action door locking apparatus built in accordance with the present invention shown in a first position.

FIG. 2 is a front perspective view of the modified face plate of a bolt action door locking apparatus built in accordance with the present invention shown in a second position.

FIG. 3 is a front perspective view of a strike plate of a bolt action door locking apparatus built in accordance with the present invention shown in a first position.

FIG. 4 is a front perspective view of a bolt action door locking apparatus built in accordance with the present invention shown with the modified face plate secured to the strike plate and a bolt in phantom.

FIG. 5 is a front elevational view of the modified face plate of a bolt action door locking apparatus built in accordance with the present invention shown in a first position.

FIG. 6 is a side elevational view of the modified face plate of a bolt action door locking apparatus built in accordance with the present invention shown in a first position.

FIG. 7 is a side elevational view of the modified face plate of a bolt action door locking apparatus built in accordance with the present invention shown in a second position.

FIG. 8 is a side elevational view of a bolt action door locking apparatus built in accordance with the present invention shown with the modified face plate secured to the strike plate.

### DETAILED DESCRIPTION OF THE INVENTION

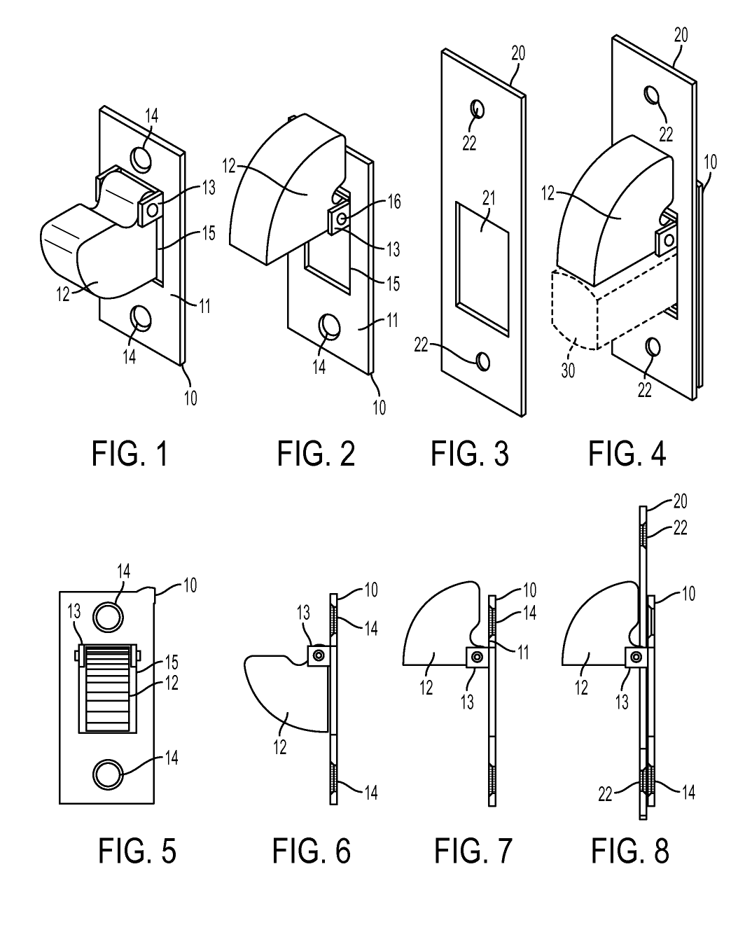

Referring now to the drawings and in particular FIGS. 1, 2, 3, 4, 5, 6, 7, and 8, a bolt action door locking apparatus built in accordance with the present invention includes a modified face plate 10 and a strike plate 20. The modified face plate 10 defines a substantially planar plate body 11 having a locking body 12 hingedly attached thereto through a pair of hinge lips 13. The plate body 11 is sized and shaped to be attached to the bolt casing of a conventional bolt lock assembly, such as a deadbolt or a latch bolt (not shown), in place of a conventional face plate (not shown) and thereby be deployed with the conventional bolt lock assembly. In this regard, the plate body 11 includes two attachment apertures 14 suitable to receive elongated fasteners that would be used to fix the bolt casing in a door (in the same manner as conventional face plates enable a bolt casing to be fixed in a door) as well as a bolt aperture 15 sized and shaped to allow a locking bolt exiting from the bolt casing to freely pass through.

Similarly, the strike plate 20 is sized and shaped to be positioned on a doorjamb (not shown) for use in substantially the same manner as a conventional strike plate for a deadbolt lock. The strike plate 20 defines a planar body having an enlarged locking aperture 21 and two securing apertures 22. The locking aperture 21 is sized and shaped to allow locking body 12 and hinge lips 13 from the modified face plate 10, as well as a locking bolt from the conventional bolt lock that the modified face plate 10 is attached to, pass through it. The securing apertures 22 are positioned to receive elongated fasteners that secure the strike plate 20 to a doorjamb in the same manner that conventional strike plates are secured to a doorjamb.

It is appreciated that conventional cylinder operated deadbolt locks, whether driven manually or by electronics and motors, as well as sliding latch bolt locks are each operative to move a locking bolt laterally to selectively position the locking bolt in an extended position wherein it extends from its bolt casing, through the face plate and beyond the edge of the door, and into the doorjamb (through the strike plate) and an retracted position wherein it is retracted back into the bolt casing. As used with conventional, swinging doors, by positioning the locking bolt in its extended position, the door is locked and other prevented from being swung open. A well known limitation of conventional bolt locking systems, however, is that simply extending and retracting a locking bolt laterally from a door (or from a doorjamb) is not effective for locking and unlocking doors that open and close by sliding laterally, such as sliding patio doors.

It is contemplated that because the modified face plate 10 and strike plate 20 in accordance with the present invention can be used with a conventional bolt locking assembly in place of a conventional face plate (or “end cap”) and conventional strike plate, respectively, the modified face plate 10 and strike plate 20 can be substituted for such conventional parts aftermarket to configure a conventional bolt locking assembly such that it is operative to lock and unlock a sliding door.

The locking body 12 is configured to swing between a first position relative to the plate body 11, as illustrated in FIG. 1, and a second position relative to the plate body 11, as illustrated in Figure through its hinged attachment to the hinge lips 13 that extend from the surface of the plate body 11. The first position defines a default position in which the locking body 12 remains and returns to in the absence of the application of a locking force that moves the locking body 12 to the second position. When the modified face plate 10 is in place on a conventional bolt locking assembly, positioned so that as the locking assembly's locking bolt 30 passes through the bolt aperture 15 when the bolt 30 is moved to its extended position, the structure of the locking bolt 30 applies locking force on the locking body 12 as the locking bolt 30 is moved to and placed in its extended position. Accordingly, the locking bolt 30 moving to its extended position causes the locking body 12 to hinge to its second position and the locking bolt 30 remaining in its extended position keeps the locking body 12 in its second position (as illustrated in FIG. 4). As the locking bolt 30 is moved back to its retracted position, the locking force is removed and the locking body 12 returns to its first position by way of gravity.

In this regard, the locking body 12 is configured to operate as a hinged fastener that, by virtue of its position and hinged attachment, is operated by the action of the locking bolt 30 and is effective to lock and unlock a door the moves laterally.

It is contemplated that in the one embodiment, a discrete hinge pin 16 is positioned between the hinge lips 13 and passes through the locking body 12, thereby attaching the locking body 12 to the hinge lips 13. In another embodiment, the locking body 12 includes an integrated hinge pin that extends from each side of its body into the hinge lips 13 and attaches it to the hinge lips 13. In other embodiments, a strap hinge or other connector which allows the locking body's 12 angled rotation may be employed.

It is appreciated that because the modified face plate 10 and strike plate 20 may be employed with conventional bolt lock assemblies, the sliding bolt action locking apparatus may enable the use newer security technologies, such as keyless digital code lock and unlock, in-lock cameras, various remote security features (including wireless access over the Internet), with sliding doors. The lack of standardization and the physical operation of the locking systems employed by sliding glass doors has commonly prevented the integration of such newer technologies, resulting in sliding doors often becoming the weak point in the security as well as not being able to have the advantages such as keyless entry. Thus, enabling the use of conventional bolt lock assemblies may allow such technological advances to be readily available for sliding doors.

The present invention has been shown and described herein in what is considered to be the most practical and preferred embodiment. It is recognized, however, that departures may be made therefrom within the scope of the invention and that obvious modifications will occur to a person skilled in the art.

What is claimed is:

1. A bolt action locking apparatus for use with a sliding bolt lock assembly, comprising:
a modified face plate attachable to a door and having an integral locking body that is movable between a first position and a second position;
a strike plate attachable to a doorjamb and configured to receive the locking body while in the first position when the modified face plate is moved adjacent to the strike plate; and
said strike plate configured to engage the locking body so as to fasten the modified face plate and strike plate when the locking body is placed in the second position while the modified face plate is positioned adjacent to the strike plate.

2. The bolt action locking apparatus of claim 1, wherein the locking body is configured to remain in the first position in the absence of a locking force.

3. The bolt action locking apparatus of claim 2, wherein the locking body is configured to move to the second position in the presence of locking force.

4. The bolt action locking apparatus of claim 3, wherein the locking body is configured to return to the first position upon the removal of locking force.

5. The bolt action locking apparatus of claim 3, wherein said modified face plate is integrated with a bolt lock assembly having a locking bolt such that positioning the bolt in an extended position applies locking force on the locking body.

6. The bolt action locking apparatus of claim 5, wherein the locking body is configured to hinge between the first position and the second position.

7. The bolt action locking apparatus of claim 6, wherein locking body is configured to hinge through an attachment to at least one hinge lip that extends from the surface of the modified face plate.

8. The bolt action locking apparatus of claim 7, wherein the strike plate includes an enlarged locking aperture sized to receive the at least one hinge lip and the locking body while in the first position.

9. The bolt action locking apparatus of claim 1, wherein said modified face plate is integrated with a sliding bolt lock assembly having a locking bolt such that moving the locking bolt from a retracted position to an extended position causes the locking body to move from the first position to the second position.

10. The bolt action locking apparatus of claim 1, wherein the locking body is configured to hinge between the first position and the second position.

11. The bolt action locking apparatus of claim 10, wherein locking body is configured to hinge through an attachment to at least one hinge lip that extends from the surface of the modified face plate.

12. The bolt action locking apparatus of claim 11, wherein the strike plate includes an enlarged locking aperture sized to receive the at least one hinge lip and the locking body while in the first position.

13. A bolt action locking apparatus for use with a sliding bolt lock assembly, comprising:
a modified face plate attachable to a door and having an integral locking body that is configured to hinge between a first position and a second position, wherein said modified face plate is integrated with a bolt lock assembly having a locking bolt such that moving the bolt to an extended position hinges the locking body to the second position and moving the bolt to a retracted position causes the locking body to hinge to the first position;
a strike plate attachable to a doorjamb and configured to receive the locking body while in the first position when the modified face plate is moved adjacent to the strike plate; and
said strike plate configured to engage the locking body so as to fasten the modified face plate and strike plate when the locking body is hinged in the second position while the modified face plate is positioned adjacent to the strike plate.

14. The bolt action locking apparatus of claim 13, wherein:
said modified face plate is attachable to a sliding door; and
said strike plate is configured to engage the locking body when the locking body is hinged in the second position such that a sliding door to which the modified face plate is attached become locked to a doorjamb to which the strike plate is attached.

15. The bolt action locking apparatus of claim 13, wherein locking body is configured to hinge through an attachment to at least one hinge lip that extends from the surface of the modified face plate.

16. The bolt action locking apparatus of claim 13, wherein the strike plate includes an enlarged locking aperture sized to receive the at least one hinge lip and the locking body while in the first position.

17. A bolt action locking apparatus, comprising:
a sliding bolt lock assembly attachable to a door and accompanying door frame, wherein said sliding bolt locking assembly includes a locking bolt extendable and retractable from a bolt casing, a modified face plate having an integral locking body that is configured to move between a first position and a second position, and a strike plate attachable to a doorjamb;
said modified face plate integrated with the sliding bolt lock assembly such that extending the locking bolt moves the locking body towards the second position and retracting the locking bolt causes the locking body to move towards the first position; and
said strike plate configured to receive the locking body while in the first position when the modified face plate is moved adjacent to the strike plate and to engage the locking body so as to fasten the modified face plate and strike plate when the locking body is in the second position while the modified face plate is positioned adjacent to the strike plate.

18. The bolt action locking apparatus of claim 17, wherein:
said sliding bolt lock assembly is attachable to a sliding door and accompanying door frame; and
said strike plate is configured to engage the locking body when the locking body is hinged in the second position such that a sliding door to which the modified face plate is attached become locked to a doorjamb to which the strike plate is attached.

19. The bolt action locking apparatus of claim 17, wherein the locking body is configured to hinge between the first position and the second position.

20. The bolt action locking apparatus of claim 19, wherein:
locking body is configured to hinge through an attachment to at least one hinge lip that extends from the surface of the modified face plate; and
the strike plate includes an enlarged locking aperture sized to receive the at least one hinge lip and the locking body while in the first position.
